(19) United States
(12) Patent Application Publication
(10) Pub. No.: US 2015/0334061 A1
(43) Pub. Date: Nov. 19, 2015

(54) SYSTEM AND METHOD FOR SENDING TIME-LIMITED MESSAGES

(71) Applicant: Poing LLC, Denver, CO (US)

(72) Inventor: Kevin Baird, Denver, CO (US)

(73) Assignee: POING LLC, Denver, CO (US)

(21) Appl. No.: 14/715,480

(22) Filed: May 18, 2015

Related U.S. Application Data
(60) Provisional application No. 61/994,321, filed on May 16, 2014.

(51) Int. Cl. H04L 12/58

(52) U.S. Cl. CPC H04L 51/043; H04L 51/30; H04L 51/24

(57) ABSTRACT

The claimed system and method offers computer readable instructions for software that enables a user to send content that is time-sensitive. This sender may set a window of time in which the content may be viewed. By limiting a time for viewing the sender is able to control the viewing of the message. In addition, the sender may control what reply capabilities, if any, a recipient may have following receipt of the message. Further, the sender may be given a list of recipients that have viewed the message. The sender may select recipients based on demographic information. Further, the sender may send a message and invite recipients to view data of the message while the data is being created as in viewing the life streaming images or sound being recorded. This system and method may be useful not only to those who wish to create temporary messages to protect privacy of the message, but also to parties such as businesses wishing to attract customers in a time-sensitive manner.

### CROSS REFERENCE TO RELATED APPLICATIONS

This application claims the priority benefit under 35 U.S.C. §119(e) of U.S. Provisional Application Ser. No. 61/994,321, filed on May 16, 2014. The disclosure of this provisional application is incorporated herein by reference in its entirety.

### FIELD

The present invention relates to transfer of text, picture, and video messages and other mixed media in a time-sensitive manner, being that the messages are only viewable for a predetermined amount of time.

### BACKGROUND

Social media has allowed us to move beyond simple text messages as in email and mobile phone texts to share text, pictures, and videos from mobile devices almost in real time. In many instances these messages, be they in text, picture, or video format are saved to a profile or on a video website for future viewing. In many cases social media companies take advantage of these websites for advertisement. Further, systems that manage email message storage and/or deletion are known.

### SUMMARY OF THE INVENTION

The claimed system and method offers computer readable instructions for software that enables a user to send content that is time-sensitive. This sender may set a window of time in which the content may be viewed. By limiting a time for viewing the sender is able to control the viewing of the message. In addition, the sender may control what reply capabilities, if any, a recipient may have following receipt of the message. Further, the sender may be given a list of recipients that have viewed the message. This system and method may be useful not only to those who wish to create temporary messages to protect privacy of the message, but also to parties such as businesses wishing to attract customers in a time-sensitive manner.

The example system is computer readable set of instructions accessible from a device capable of sending messages via the internet, cellular data, or other form of message content transmittal system, for a system wherein a sender creates a message containing data on the device; the sender selects at least one of a recipient to receive the message on at least one of a recipient's device capable of receiving messages via the internet, cellular data, or other form of message content transmittal system; the sender specifies a time amount for which the message will be available for viewing on the at least one of a recipient's device; the sender sends the message to the at least one recipient's device; the at least one recipient may view the message on the at least one recipient's device if the time amount specified has not been surpassed; the least one recipient's device produces a notification that the message is available for viewing for the time amount specified by the sender; and the sender receives a report as to whether the at least one recipient has viewed the message. Further, the sender may specify whether a reply by the at least one recipient will be allowed. In addition, the sender may specify more than one recipient and for each of the more than one recipient whether that recipient can respond to the sender alone or to the sender and all of the more than one recipient. The sender may specify whether the message is deleted after time amount for which the at least one recipient will be able to view the message is surpassed.

Further, a notification of the sender's message may be produced on the recipient's device. This notification may have limited information such as only time that the message is sent and time the message is able to be viewed. When and only when the recipient has viewed the message, the recipient may have access to information pertaining to the message even after the time amount specified by the sender is surpassed. The notification may be displayed in text or graphical format. The graphical format or graphical display may change of time or depending on urgency of the message. For example the color of the display or graphic may change with decreased viewing time. Alternately the sender may select an urgency for the message.

Still further, the report generated to the sender may contain data including but not limited to the amount of time between when the one recipient's device received the message and when the one or more recipients viewed the message, how many of the at least one recipient opened the message, how many of the at least one recipient responded to the message, and recipient demographic information.

Even further, the examples system will enable the sender to select recipients from a pool of user recipients, the pool of user recipients being recipients that use the computer readable set of instructions of the current claim, and wherein the recipients may be chosen based on a set of demographic information pertaining to the recipient.

In another example, the system may enable data including video or audio to be recorded. While recording the sender may select a recipient is selected and send the message. The recipient may view the message during the time of the recording.

In another example a method for sending a time-sensitive message from a device is presented. The method may comprise entering contents of a message selected from the group consisting of words, letters, a picture file, or a video file into a message screen; setting a time length that the message can be viewed; selecting at least one of a recipient; causing to send the message to the at least one recipient's device; receiving by the sender a report as to whether the at least one recipient has viewed the message; choosing by the sender whether a reply by the at least one recipient is allowed, and if more than one recipient is chosen whether those recipients may reply to the sender or all recipients; and optionally causing the deletion of the message after the time amount specified by the sender is surpassed. The method may further comprise producing on the at least one recipients device a notification of the message, wherein the notification indicates only the time the message was sent and the time amount specified by the sender, and further comprising viewing of the message by the recipient, wherein after the at least one recipient views the message, the at least one recipient accesses information pertaining to the message even after the time amount specified by the sender is surpassed, the information being selected from a group consisting of identity other recipients, identity of sender, time message sent, and the time the message expired.

Further, the method may comprise producing on the at least one recipients device a notification of the message, and wherein said notification contains graphics, and wherein said graphics accomplish a change, the change being linked to an urgency level of the message. The report as to whether the at least one recipient has opened the message also contains data selected from a group including the amount of time between when the one recipient's device received the message and when the one or more recipients viewed the message, how many of the at least one recipient opened the message, how many of the at least one recipient responded to the message, and recipient demographic information.

Even further, the method may comprise selecting by the sender recipients from a pool of user recipients, the pool of user recipients being recipients that use the computer readable set of instructions of the current claim, and wherein the recipients may be chosen based on a set of demographic information pertaining to the recipient.

In addition the method may comprise acquiring video or audio content, wherein the sender selects the at least one recipient while a recording of the video or audio data is occurring, sends the message during the recoding, and least one recipient views the recording during the time of the recording.

Other aspects of this invention will appear from the following description and appended claims, reference being made to the accompanying drawings forming a part of this specification wherein like reference characters designate corresponding parts in the several views.

### BRIEF DESCRIPTION OF DRAWINGS

FIG. 1 schematically illustrates a system and method for sending time-sensitive messages.

FIG. 2 illustrates a flow sheet for a method for a user to determine whether or not a recipient will be able to respond to transmitted content.

FIG. 3 illustrates a flow sheet for a method for a user to determine the nature in which a recipient or group of recipients might interact with the sender.

FIG. 4 schematically illustrates a method of determining the nature in which a recipient or group of recipients might interact a creator's content.

FIG. 5 illustrates a flow sheet for a method of sending content in a time sensitive manner in which the recipient(s) are required to view the content before its set expiration time.

FIG. 6 illustrates a flow sheet for a method of sending content in a time sensitive manner if a recipient(s) views content or participate in a session before the expiration time is achieved, said recipient(s) may have additional viewing capabilities even after the expiration time is achieved.

FIG. 7 illustrates a flow sheet for a method and a style of notifications regarding a message or session.

FIG. 8 schematically illustrates one possible software user interface and features.

FIG. 9 illustrates a flow sheet for a method of utilizing changing visual color cues to indicate or reflect changes made to a timer apparatus.

FIG. 10 illustrates a flow sheet for a method of utilizing changing visual color cues to indicate or reflect level of urgency of a message.

FIG. 11 illustrates a flow sheet for a method of revealing limited information on a device notification system until user interacts with notification at which time, more information about the message is revealed.

FIG. 12 illustrates a flow sheet for how a database of users may assess specific information on a user before sending content.

FIG. 13 illustrates a flow sheet for how a content creator might utilize a device to record and send information simultaneously.

FIG. 14 schematically illustrates one possible software user interface and features regarding a notification menu.

### DETAILED DESCRIPTION

In this disclosure a number of terms and abbreviations are used. The following definitions are provided. The term sender or creator refers to a person or entity that may create a message. The terms recipient, user, or participant refer to any entity that may receive or view a message or engage in a live session. Message or content refers to any digital information that a user has created or sourced that could be original and unique or copied from another application, or any other source material such as text, email message, html content, photo image, video, location information and/or other digital data conceivable that is transmittable from an electronic device be it live or previously recorded. The term session refers to but is not limited to an instant message (IM), short message service (SMS), live video, audio conference, or a recording of any kind on a device. The term transmitted, sent or send refers to the action of passing any digital content from one device or entity to another one or more devices or entities. An electronic device capable of sending and receiving messages may be a personal computer, whether desktop or laptop connected via wi-fi (wireless) or wired to the internet, a handheld mobile device that may be connected wirelessly to the internet or through a cellular signal to the internet, a cellular phone that may be connected via wi-fi or cellular signal, and or any other device conceived for sending and receiving text, voice, picture and video content, messages or digital content of any kind. The term message may refer to a textual message, a message that is or contains an electronic or digital picture file, a message that is or that contains an electronic or digital video file. A software program or application is a digitally coded medium that contains computer readable instructions. An application is a software program with computer readable instructions.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

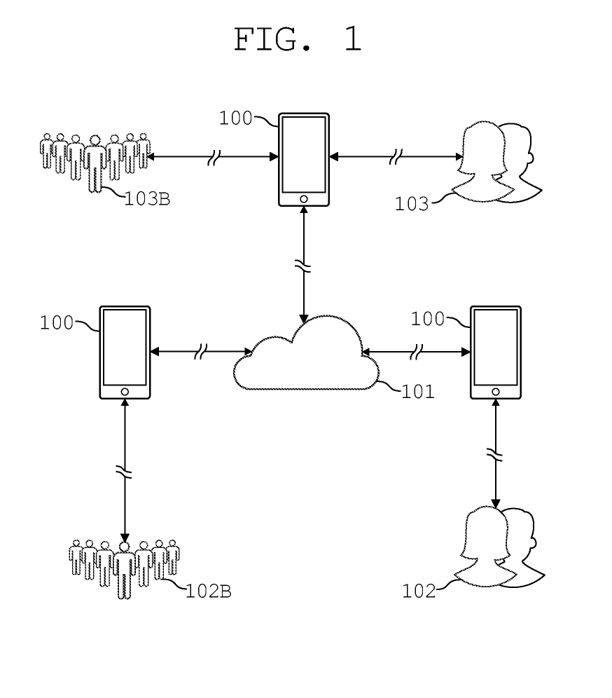

Now referring specifically to FIG. 1, FIG. 1 schematically illustrates an example system and method for sending time-sensitive messages. A sender, being a person(s) 102 or a business entity 102B who are “creators”, may create content or message, being an image or video, or location, or the like, using a mobile handheld device or mobile phone or a computing device such as a laptop or desktop computer 100. These devices 100 are connected to recipients' 103B and users' 103 devices 100, through a network 101, in a wired or wireless manner, via an internet or other communication network, such as a cellular network. The recipients or users 103, 103B may be persons and/or other business entities. Computer readable instructions for software applications may be encoded to the hard drive of a computing device 100 for use on various user devices 100 via access of the internet or cellular network 101. Copies of computer readable instructions being a software application program for the example system and method for sending time sensitive messages may be downloaded and saved on user's devices 100 from computing devices storing the software application program via the internet or cellular network. Various hardware and software components may be used to implement these actions.

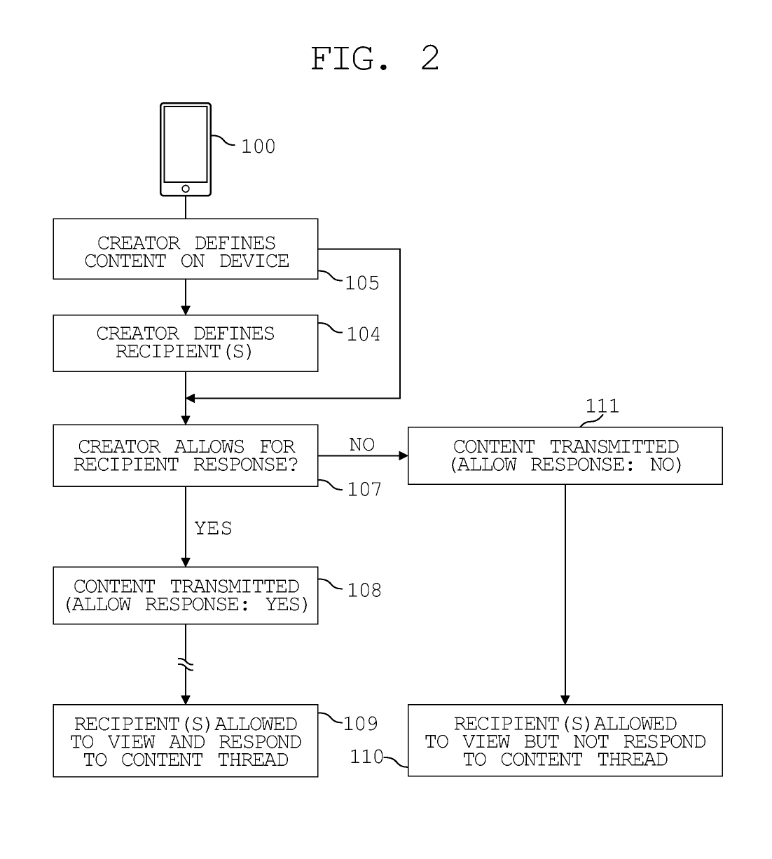

FIG. 2 illustrates a flowchart for a sender (FIG. 1, 102) to determine whether or not a recipient (FIG. 1, 103) will be able to respond to transmitted content. A sender generates or defines content 105 on a device 100. Following content generation 105, the sender may define which recipients or users will be allowed to view or receive 104 the content. The sender can indicate whether a recipient will be allowed to respond to message 107. If manually determined, one example of how this action may be applied by sender is to answer a query prompted by the message system which may read: Allow recipient to Respond: Yes 108 or No 111. This may be applied to one or more recipients or a network of individuals who may have access to the sender's content. This process 104 may also transpire automatically, based on a software interface setting or preference or due to a particular circumstance. Optionally, this step could be bypassed completely as this is not a requirement of this invention. The sender's message 102 will then be transmitted from the sender's device to recipient(s) devices). If applicable, each recipient will have the ability to view some or all of the sender's content in either scenario. If the sender allowed for responses (e.g. Allow for Responses: Yes) 108, the software will enable recipient(s) to respond to the same message thread or in any other possible means of response 109. If the sender did not allow for responses (one possible example: Allow for Responses: No) 111, the recipient will have limited ability to respond to content. In one example 110, the recipient will not be able to respond in any capacity. In another possible application of this invention, a recipient may have some limited response capabilities.

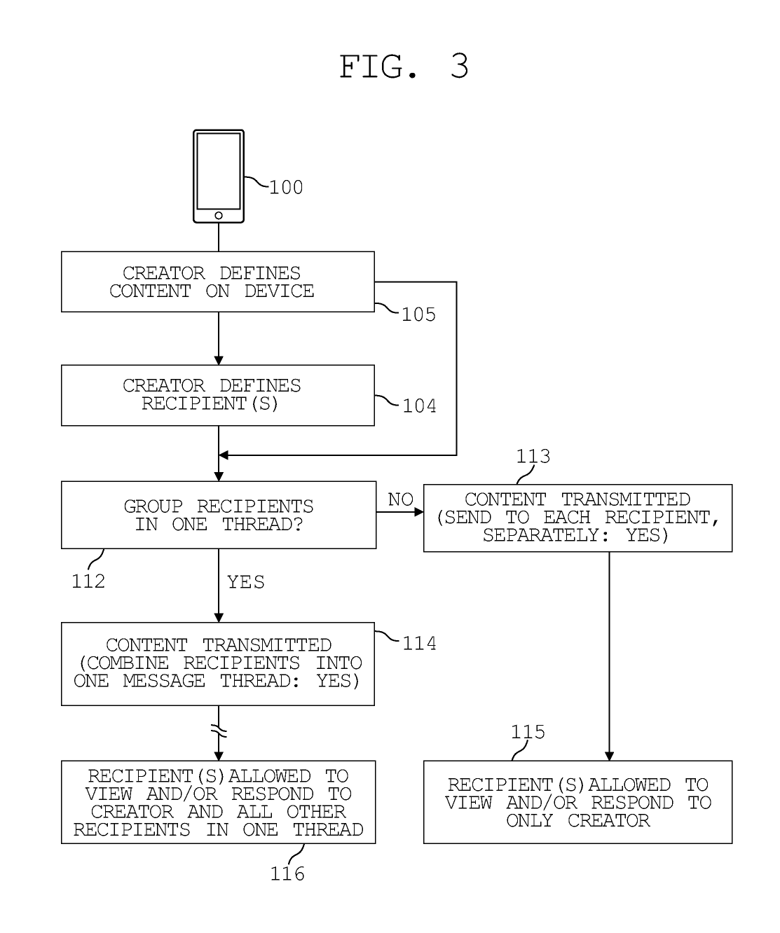

FIG. 3 illustrates a flowchart for a method for a sender to determine the nature in which a recipient or group of recipients might interact with the sender. Applications of this concept might be utilized in a messaging application or social networking platform. A sender defines content 105 on a device 100. A list of recipients may automatically be defined or the sender may manually define who will be allowed to view or receive a message 104. This process may take place automatically or could be entered by the sender manually via a list of other users or potential recipients.

In this example of the invention's application, a sender indicates whether or not list of recipients should be grouped (e.g. included in one message thread) 112. If the sender chose to group recipients (e.g. combine recipients into one message thread: Yes) 116, the software will enable recipient(s) to respond to some or all of the list of other recipients 116 in one or more message threads or in any other possible means of response. If the sender chose to send to each recipient, separately (e.g. send to each recipient, separately: Yes), the recipients will be enabled to only respond to the creator 115—or possibly not at all. In this path 113, each individual recipient may or may not be made aware of the other recipient(s) in the list or group of recipients and may only be allowed to respond to the sender or have limited or no ability to respond to the other recipient(s).

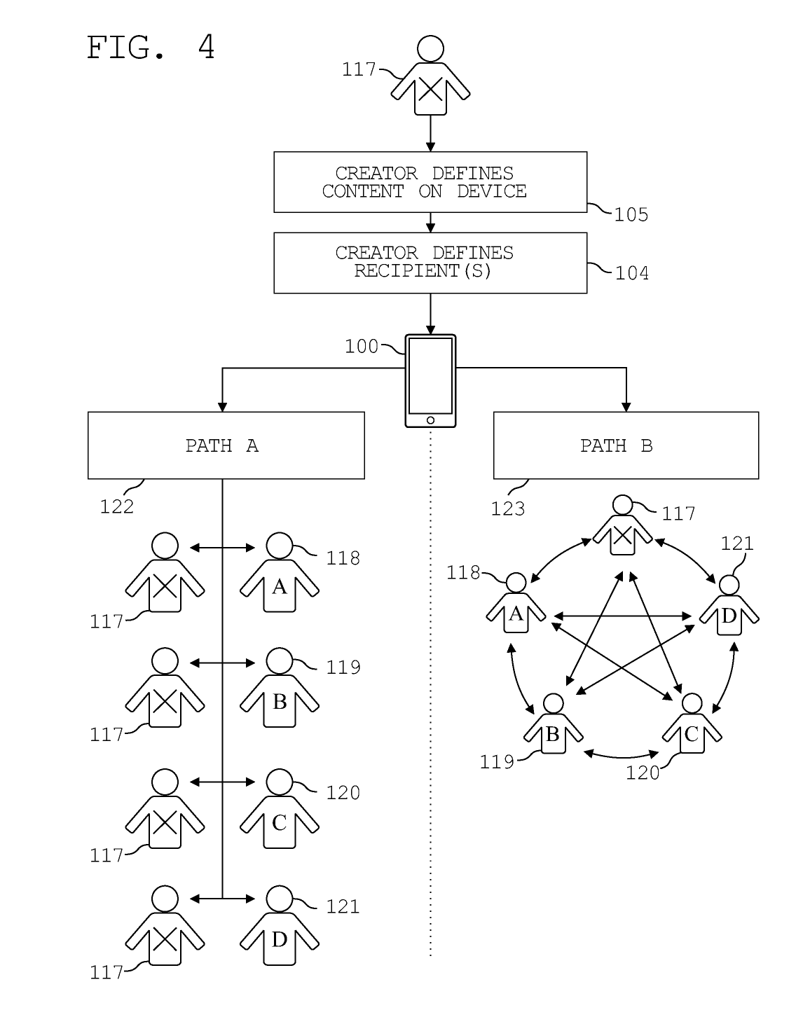

FIG. 4 is a schematic illustrating a method of determining the nature in which a recipient or group of recipients might interact with a creator's content. Applications of this concept might be utilized in a messaging application or social networking platform. A sender 117 defines content 105 on a device 100. A list of recipients may automatically be defined or the sender may manually define who will be allowed to view or receive a message 104. This process may take place automatically or could be entered by the sender manually via a list of other users or potential recipients.

In this example of the invention's application, a sender 117 indicates whether or not list of recipients should be grouped (e.g. included in one message thread). If the sender chose to group recipients, as in PATH B 123, the software will enable recipient(s) 118-121 to respond to some or all of the other recipients 118-121 and the sender 117 in one or more message threads or in any other possible means of response. One example result of Path B 123 is a multi-way conversation between the creator and all recipients. In this example there are four recipients 118-121. However, note that this invention can be applied to any conceivable number of recipients.

If the sender chose to send to each recipient, separately PATH A 122, the recipients 118-121 will be enabled to only respond to the sender 117—or in some possible applications, there will be no response allowed at all. One example result of PATH A 122 is multiple two-way threads between the creator and each recipient. In this path 122, each individual recipient may or may not be made aware of the other recipient(s) in the list or group of recipients and may only be allowed to respond to the sender 117 or have limited or no ability to respond to the other recipient(s) 118-121.

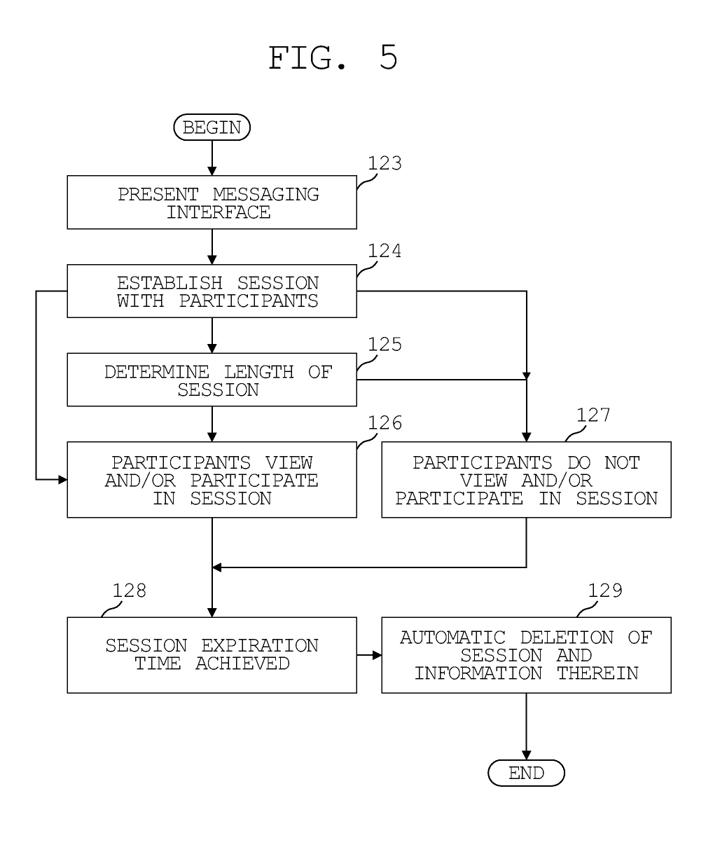

FIG. 5 illustrates a flowchart for a method of sending content in a time sensitive manner where recipients are required to view the content before a set expiration time. In this example, a sender begins by opening the software application on his/her device and the messaging interface is present or viewed on the device 123. This step is applicable to all previous figures as a preliminary step to generating a message 105. The user, by generating content 124 or establishing a session with selected participants, as described above in previous examples FIGS. 2, 3 and 4 105, 104 and determines how long that content will be viewable 125 or in other words the length of the session, before transmitting message. The amount of time allowed before deleted 125 may be chosen by the sender or automatically assigned by the application based on predetermined settings or preferences. The time expiration 125 settings or preferences may be automatically generated by the software.

As described above the sender establishes a session 124, and the length of time that the session is viewable is determined 125. Participants may be alerted or notified of sent content or live session as to ensure that they do not miss the opportunity to view content. The participant may view the session 126 or not 127. At the set expiration time the session will expire 128. In this example, the expiration of content or the ability to view a session is independent from the expiration time of the content. Likewise, a recipient(s) will only have the ability to view content and/or participate in a session 126 until the expiration time is achieved 128. The expiration time quantity can be equal to any conceivable amount of time, being at least about one second, ten seconds, one minute, ten minutes, or even thirty minutes, or one hour, or two hours, or twenty-four hours, or longer. The expiration might also take place based on the achievement of specific parameters, activities or methodology. One example of one of these parameters would be a setting that would delete the content only after it has been viewed by all recipients. If the participants do not view content or participate in the session 127 before the expiration time is achieved, the content may be automatically deleted by the software 129 or manually deleted by a user(s) or sender and the recipient(s) will not be allowed to view content.

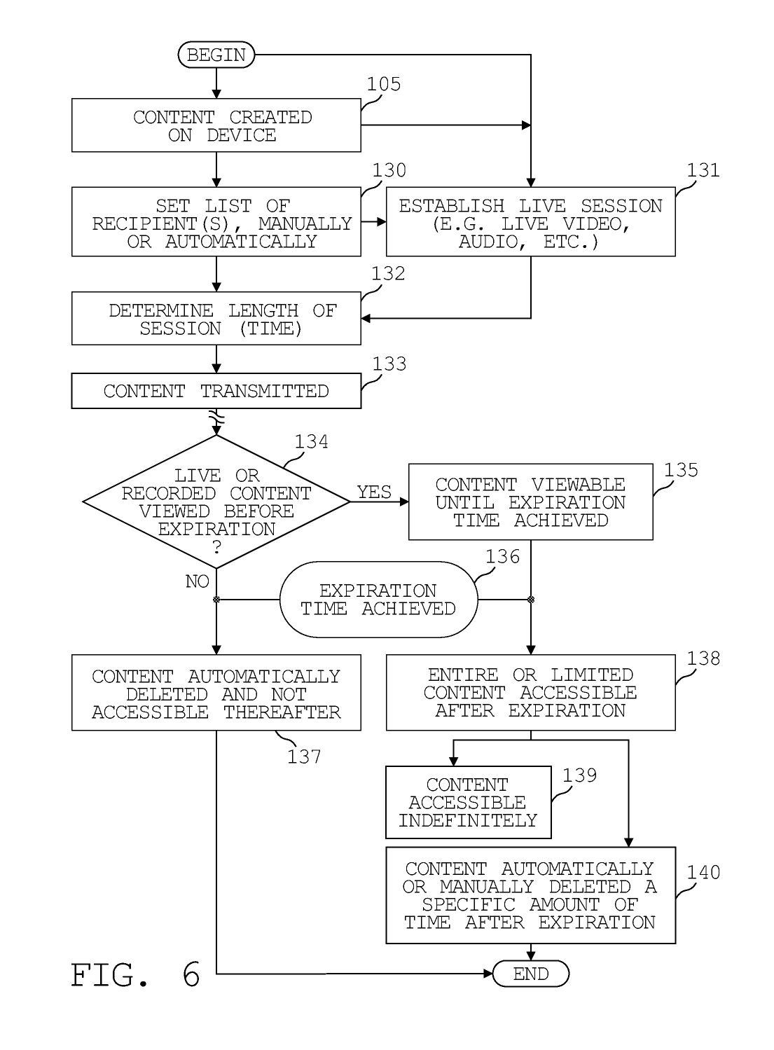

FIG. 6 illustrates a flowchart for a method of sending content in a time sensitive manner. If a recipient(s) view content or participate in a session before the expiration time is achieved, said recipient(s) may have additional viewing capabilities even after the expiration time is achieved. In this FIG. 6 example, to begin a session, content is defined 105 or a session is established on a device. A sender may set a list of recipients manually or the list may be automatically generated 130. A live session may also be established 131 and/or invited recipients are allowed to view and receive content until the session expires or expiration time is achieved 136. A length of time may be determined for the session 132. After transmission 133, if the content is not viewed or session is not joined before expiration time 136 is achieved, content will automatically be deleted 137 and will no longer be accessible by recipient(s). If content is viewed or session joined by recipient(s) 135 before expiration time is achieved 136, said recipient(s) will be allowed to view specific information regarding the content, for instance other recipients, sender, time message sent, and the time the message expired, even after the expiration time is achieved 138. If the message is not viewed before expiration no information about the message including sender, content, or time may be available to the recipient. Additional information may be available indefinitely 139 or may be automatically or manually deleted a specific amount of time after expiration 140 (e.g. 24 hours).

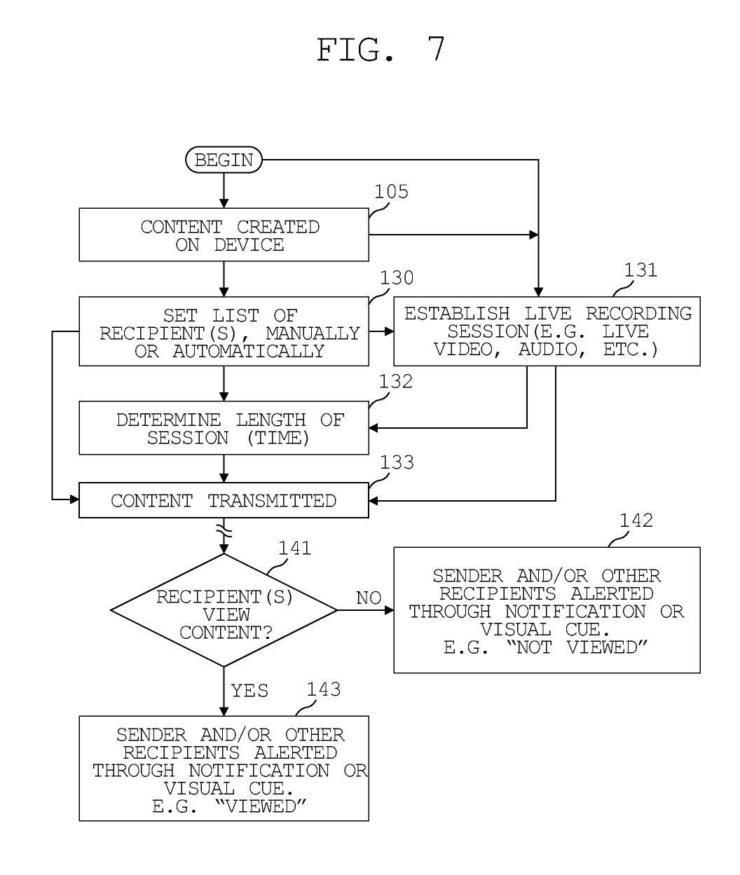

FIG. 7 illustrates a flowchart for a method and style of notifications regarding a message or session. Some software systems and devices allow for notifications regarding incoming messages or data. This invention takes this process a step further by providing additional information to senders and recipients. As in previous examples, content is created on a device 105, a list of recipients is produced 130, a live recording session may be started 131, the length of time for the session is determined 132, and the content is transmitted to the recipients 133. Further, in this example the system that uses visual and sound alerts to notify a recipient(s) or sender(s) of when a message has been viewed or a session has been joined 141. If a system detects that a recipient has viewed a message 143, a notification is automatically generated to alert the sender and/or other recipients in real time. If the content is not viewed then the sender and/or recipients may be alerted with a visual or sound cue 142. A visual cue for example, may be text displayed on the sender's or recipient's device, such as the phrase “message not viewed”. This system FIG. 7 may be especially important when sending time sensitive messages or content with an expiration time 132 so recipients and senders know who viewed the content before and after it expires.

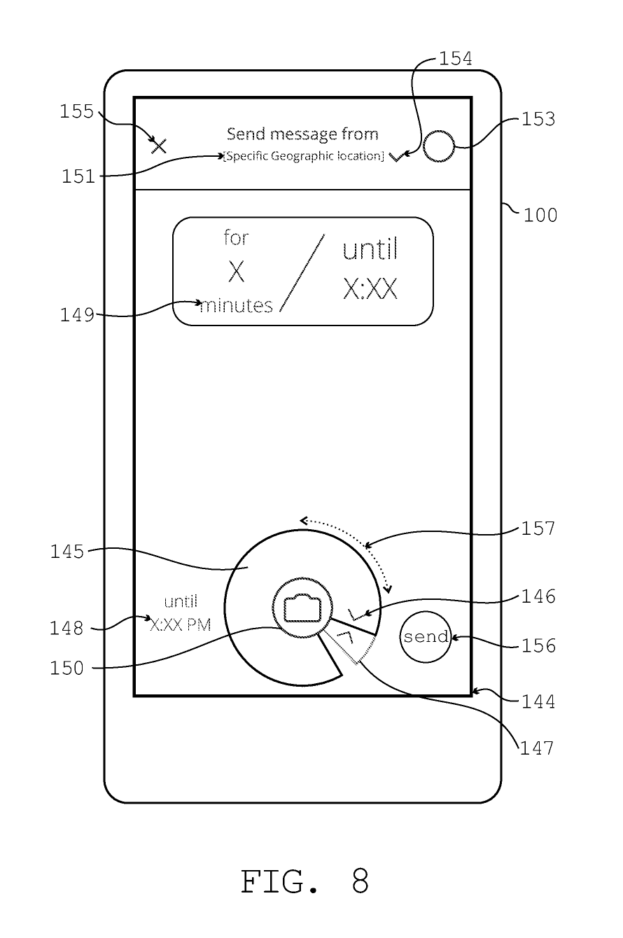

FIG. 8 schematically illustrates one example software user interface and features. In this example interface, there is a device 100 with an interactive screen 144 that is possibly responsive to human touch. Illustrated is a diagrammatic screenshot showing how some various features might be presented to a user or sender at the time of message generation, before transmission. There is a timer 145 that users can control by spinning or turning in a counter clockwise or clockwise motion 157 or simply touching a circular timer 145 or two-dimensional wheel with their fingers to manually manipulate the amount of time that a time sensitive message will be viewable before expiration. The color of the timer 145 may change indicating the changing increments of time in real-time, direct relation with the manual manipulation. This function would be helpful in visually alerting a user that the amount of time is changing as they manipulate the timer 145. There may be arrows 146 or a simple symbol that will visually indicate the direction or manipulation possibilities 147 of the timer. Another indication of the effects of manually manipulating the timer might be displayed to the user by indicating the quantity of time the message might remain 149 or what time the message might expire 148. This timer could be used and helpful for any other conceivable digital timer utility. A user might be allowed to take a picture from the same screen with the tap of a digital button or icon 150. The camera aperture might be active, displaying the visual content in the background. A user might also have the capability of sending location 151 or geographical information 154 in a message for a specified period of time 148. With access to additional functions 153 this example application could be useful in many ways. Once the content has been defined, the user could choose to transmit the data 156 to recipients or could cancel all actions and start over 155.

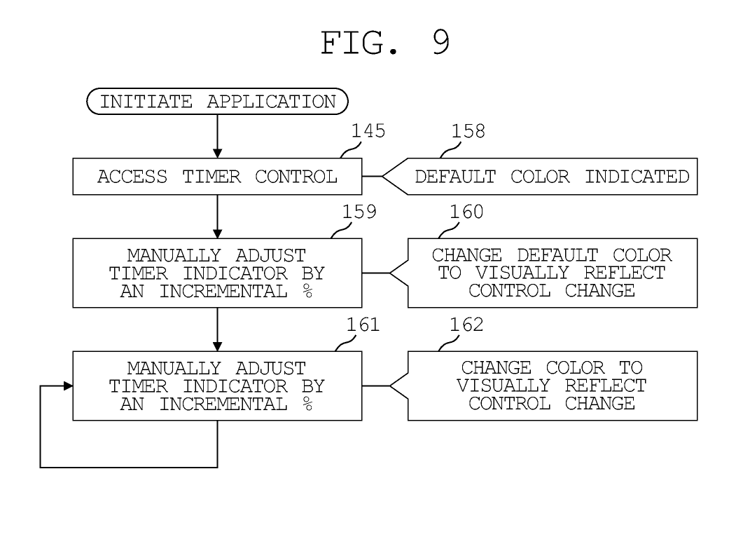

FIG. 9 illustrates a flowchart for a method of utilizing changing visual color cues to indicate or reflect changes made to a digital timer apparatus 145. The example method may be useful to visually indicate when a digital timer is being manipulated to adjust a quantity of time by an incremental or random percentage 159. A system might use two or more colors to achieve this purpose. In this example, the timer might have a default color 158. This default color 158 would change 160 if the timer is manually adjusted 159 by a user or even automatically by the application software. This process could be repeatable in many definite increments or indefinitely to reflect continued timer manipulation 161.

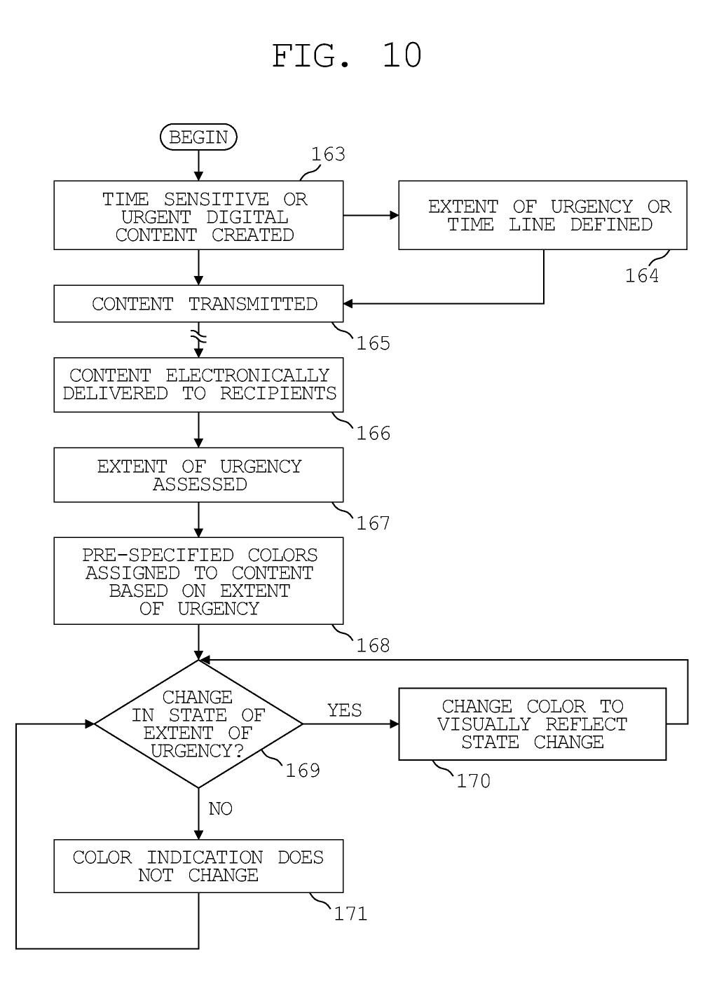

FIG. 10 illustrates a flowchart for an example method of utilizing changing visual color cues to indicate or reflect level of urgency of a message. This invention would be useful for a user to visually recognize the—potentially fluctuating—extent of urgency for time-sensitive messaging application. This could also be used for any conceivable method of indicating static or changing level of urgency for digital communications or messaging. A system might use two or more colors to achieve this purpose. In this example, a sender or user would generate time sensitive content 163, manually or automatically define the level of urgency 164, transmit content 165 to one or more recipient devices 166. The recipient(s) device software would assess the level of urgency indicated 167 and automatically assign a color(s) to visually indicate the extent or level of urgency of the message. If there is a change in the state of urgency—which could be manually changed by the sender or automatically assessed by the application software—the color would change to reflect the altered state of urgency 170. If the level of urgency does not change 169, the color will not change 171. A level of urgency may correlate to how important the content is or the time length of the session, for example.

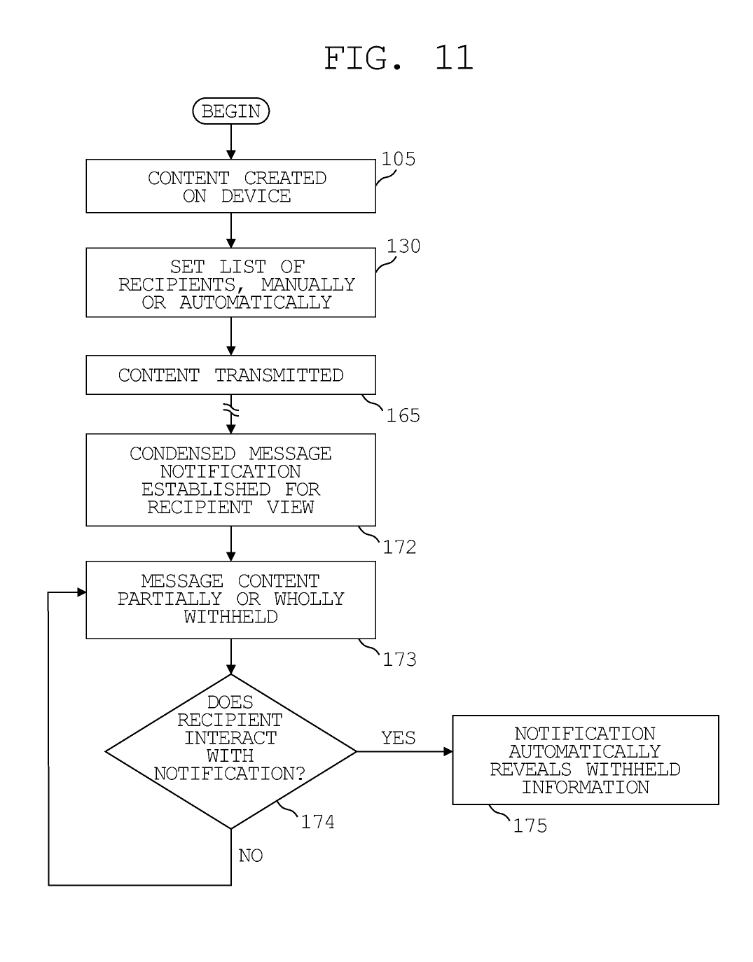

FIG. 11 illustrates a flowchart for an example method of revealing limited information on a device notification system until user interacts with notification at which time, more information about the message is revealed. For instance identity of other recipients, identity of sender, time message sent, and the time the message expires may be revealed only after opening the message. This invention would be useful for incentivizing a recipient(s) to open or view a message in its entirety. In other words, digital message notifications often show most or all of a message's content and thus a user may not need or want to further engage with the sender or the messaging software application. In this application of this invention, a sender or user would generate content 105, manually or automatically define the list of recipients 130, transmit content 165 to one or more recipient devices. Upon receiving a message, a recipient's device will allow for a condensed notification message to alert the recipient of the received message 172. This notification would contain a condensed version of the message's content 173. The notification would withhold crucial or trivial information about the content 173 to encourage the recipient to interact with the message further. The additional information would not be revealed until the user engages with the notification 174. An example of engagement might be simply viewing the notification, tapping on or swiping over notification or any other conceivable means of user interaction. When a user further engages with the notification, the withheld information would be revealed 175.

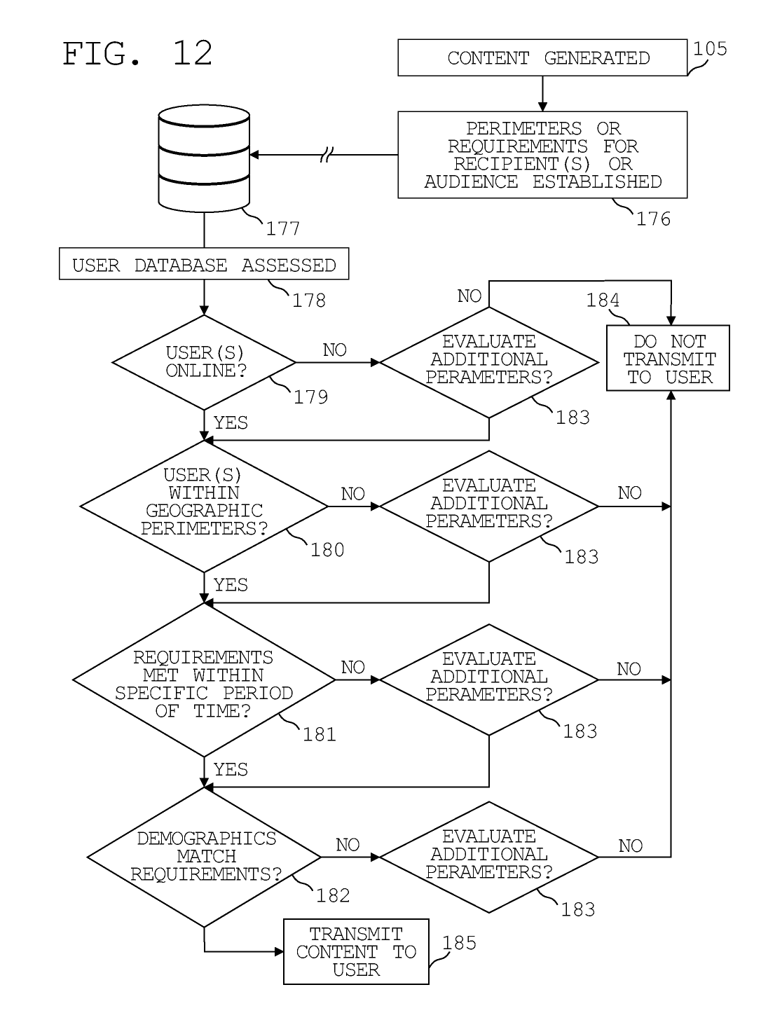

FIG. 12 illustrates a flowchart for how a database of users may assess specific information on a user before sending content. This invention would be useful for a business entity or individual to send content and know that it will only be received by individuals who fit their predefined target audience. This would be especially useful for sending time-sensitive content or advertisements to individuals or entities who are in a specific geographical location within a specific period of time. FIG. 12 illustrates several example parameters 179, 180, 181, 182 for a possible use of this invention, though this concept might not be limited to only these examples. For instance the program may query how many and which users are connected to an internet connection 179, which and/or how many users are within a certain geographic location 180, how many or which users qualify based on the predefined parameters within a specific period 181, and/or how may or which users are of any number of certain demographics 182. These demographics may include but not be limited to location, age, gender, ethnicity, frequency of use, interests, education, frequency and content of queries, professional interests, occupation, background, and other specific user related data. In this example of the invention, a sender—be it a business or user generates content 105, defines the parameters or requirements for the desired recipients 176, transmits content to a centralized database 177 which would contain a list of users and the automated ability to cross check 178 the parameters against the user database list to assess whether or not the potential user(s) will be eligible to receive the content and automatically assess if the content will be transmitted 185 to user(s) or not 184. The sender may have the ability to assess information on which users viewed the message before expiration time and the level of engagement of a specific or a group of users to better understand the effectiveness of the message campaign.

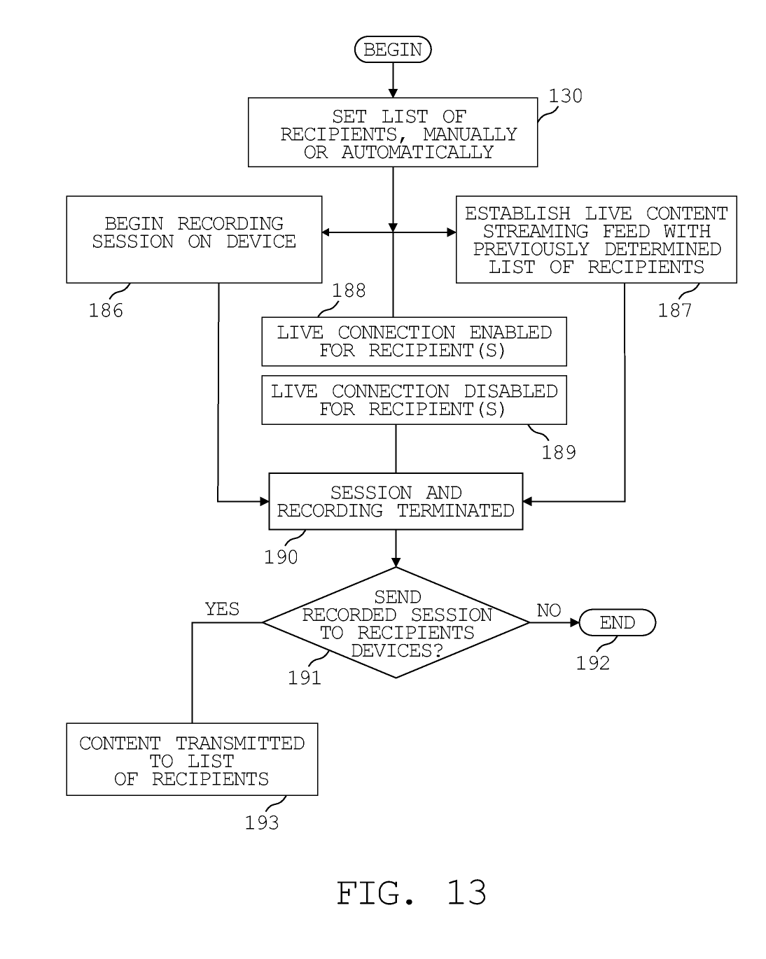

FIG. 13 illustrates a flowchart for how a content creator might utilize a device to record and send information, simultaneously. This invention would be useful in a live video or audio streaming session if a user desires to access the live session to then send the recorded content to a given list of recipients, after the session has expired. In this example, a sender sets the list of recipients—this could happen manually or automatically 130. The sender then begins a live video or audio streaming session with previously determined list of recipients 188. While the live session is taking place, the device and software will automatically begin recording 186 for potential use later reference. Recipients may or may not receive a notification which would be automatically generated as an alert that a live session has begun 189. When applicable, this notification would act as an invitation to the event or live streaming content 188. Recipient(s) may or may not join while the session is live but because there will be a recording of the session, the sender will have the option to transmit recordings 191, after the session has expired 190. If the creator chooses to send the recorded session, the content will be transmitted to recipient(s) 193. The sender may also have the option to not send the recorded content 192 and the content may or may not be saved for later use.

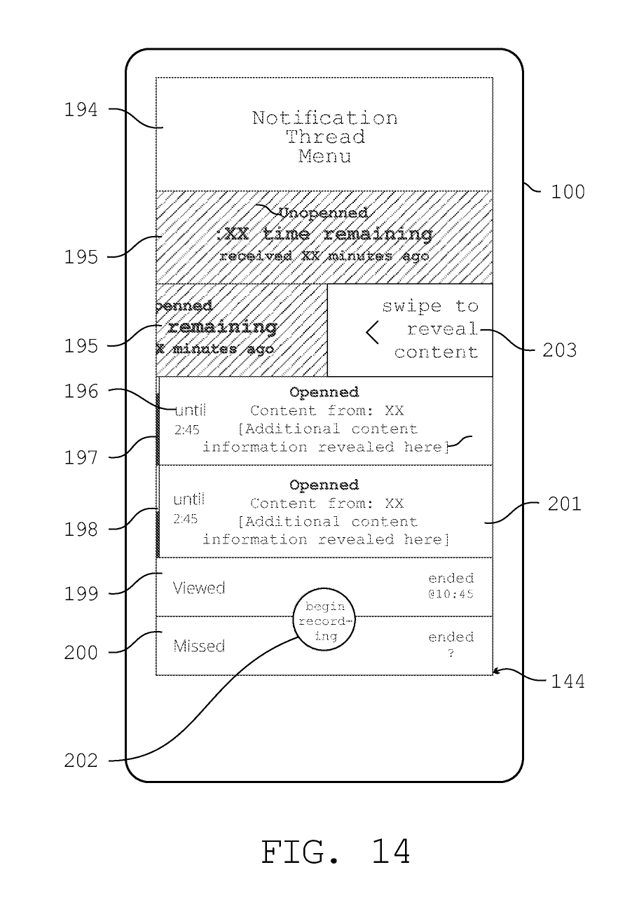

FIG. 14 schematically illustrates an example software user interface and features regarding a notification menu 194. In this example interface, there is a device 100 with an interactive screen 144 that is possibly responsive to human touch. This is a diagrammatic screenshot demonstrating how some various notification features might be presented to a user or sender. Messages that have not yet been opened may have a notification bar 195 that displays limited if any of the message's content until the recipient engages the notification 203. In this example, an engagement may consist of a recipient swiping a finger across the device screen 203 to reveal or open a message 201. In other possible examples, the user might only need to tap, double tap, or engage with the message or notification intentionally in any way to reveal the additional content or any conceivable method of conscious interaction. Once a message has been revealed, there may be a colored bar 197 to indicate the level of urgency 198 or the amount of time remaining 196 before the message expires. Another type of notification is indicative of after a message and some or all of its content have expired and whether that message was viewed before expiration 199, or not 200. There may also be an option to generate a completely new message or respond to senders existing message thread 202.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A computer readable set of instructions accessible from a device capable of sending messages via the internet, cellular data, or other form of message content transmittal system, for a system wherein:
a. a sender creates a message containing data on the device;
b. the sender selects at least one of a recipient to receive the message on at least one of a recipient's device capable of receiving messages via the internet, cellular data, or other form of message content transmittal system;
c. the sender specifies a time amount for which the message will be available for viewing by the recipient;
d. the sender sends the message to the at least one recipient's device;
e. the at least one recipient may view the message on the at least one recipient's device if the time amount specified has not been surpassed;
f. the at least one recipient's device produces a notification that the message is available for viewing for the time amount specified by the sender; and
g. the sender receives a report as to whether the at least one recipient has viewed the message.

2. The computer readable set of instructions for the system of claim 1, wherein the sender specifies whether a reply by the at least one recipient will be allowed.

3. The computer readable set of instructions for the system of claim 1, wherein the sender specifies more than one recipient and for each of the more than one recipient whether that recipient can respond to the sender alone or to the sender and all of the more than one recipient.

4. The computer readable set of instructions for the system of claim 1, wherein the message is deleted after time amount for which the at least one recipient will be able to view the message is surpassed.

5. The computer readable set of instructions for the system of claim 1, wherein after the at least one recipient views the message, the at least one recipient may have access to information pertaining to the message even after the time amount specified by the sender is surpassed.

6. The computer readable set of instruction for the system of claim 5, wherein information pertaining to the message may be selected from a group consisting of identity other recipients, of identity sender, time message sent, and the time the message expired.

7. The computer readable set of instructions for the system of claim 1, wherein the message contains data in the form selected from the group consisting of text, picture, video, sound, live streaming data, location information, and advertisement.

8. The computer readable set of instructions for the system of claim 1, wherein the notification indicates information about the message that may be one or more of information selected from a group including the time the message was sent and the time amount specified by the sender.

9. The computer readable set of instructions for the system of claim 1, wherein the indication of the time amount specified by the sender is displayed graphically, and wherein said graphics accomplish a change, the change being linked to an urgency level of the message.

10. The computer readable set of instructions for the system of claim 9, wherein the urgency level of the message may be chosen from the amount of time remaining prior to time amount specified by the sender, an importance value chosen by the sender, and a number of recipients who have viewed the message.

11. The computer readable set of instructions for the system of claim 10, wherein the change in the graphics may be a color change.

12. The computer readable set of instructions for the system of claim 1, wherein the report as to whether the at least one recipient has opened the message also contains data selected from a group including the amount of time between when the one recipient's device received the message and when the one or more recipients viewed the message, how many of the at least one recipient opened the message, how many of the at least one recipient responded to the message, and recipient demographic information.

13. The computer readable set of instructions for the system of claim 1, wherein the sender may select recipients from a pool of user recipients, the pool of user recipients being recipients that use the computer readable set of instructions of the current claim, and wherein the recipients may be chosen based on a set of demographic information pertaining to the recipient.

14. The computer readable set of instructions for the system of claim 1, wherein the data may be video or audio data, and wherein the at least one recipient is selected while a recording of the video or audio data is occurring, and wherein the message is sent during the recording, and wherein the recipient may view the message during the time of the recording.

15. A method for sending a time-sensitive message from a device, wherein the device is encoded with a set of readable instructions for carrying out the method, the method comprising the steps of:
a. creating contents of a message selected from the group consisting of words, letters, an images, audio, and video;
b. setting a time length that the message can be viewed;
c. selecting at least one of a recipient;
d. causing to send the message to the at least one recipient's device;
e. receiving by the sender a report as to whether the at least one recipient has viewed the message;
f. choosing by the sender whether a reply by the at least one recipient is allowed, and if more than one recipient is chosen whether those recipients may reply to the sender or all recipients; and
g. optionally choosing to cause the deletion of the message after the time amount specified by the sender is surpassed.

16. The method of claim 15 further comprising producing on the at least one recipients device a notification of the message, wherein the notification indicates only the time the message was sent and the time amount specified by the sender, and further comprising viewing of the message by the recipient, wherein after the at least one recipient views the message, the at least one recipient accesses information pertaining to the message even after the time amount specified by the sender is surpassed, the information being selected from a group consisting of identity other recipients, identity of sender, time message sent, and the time the message expired.

17. The method of claim 15 further comprising producing on the at least one recipients device a notification of the message, and wherein said notification contains graphics, and wherein said graphics accomplish a change, the change being linked to an urgency level of the message.

18. The method of claim 15, wherein the report as to whether the at least one recipient has opened the message also contains data selected from a group including the amount of time between when the one recipient's device received the message and when the one or more recipients viewed the message, how many of the at least one recipient opened the message, how many of the at least one recipient responded to the message, and recipient demographic information.

19. The method of claim 1 further comprising selecting by the sender recipients from a pool of user recipients, the pool of user recipients being recipients that use the computer readable set of instructions of the current claim, and wherein the recipients may be chosen based on a set of demographic information pertaining to the recipient.

20. The method of claim 1, wherein the data may be video or audio data, and further comprising the sender selecting the at least one recipient while a recording of the video or audio data is occurring, sending the message during the recording, and viewing of the message by the at least one recipient during the time of the recording.
